(19) United States
(12) Patent Application Publication
(10) Pub. No.: US 2011/0258219 A1
(43) Pub. Date: Oct. 20, 2011

(54) Reusable and trackable greeting card

(76) Inventors: Ian Ross, Dartmouth (CA); Nancy Cashwell, Dartmouth (CA)

(21) Appl. No.: 12/798,988

(22) Filed: Apr. 15, 2010

(51) Int. Cl. G06F 17/30; G06K 19/00; G09F 1/04

(52) U.S. Cl. 707/769; 40/124.06; 235/487; 707/E17.014; 707/802; 707/E17.044

(57) ABSTRACT

A reusable greeting card is provided. The reusable greeting card comprises a reusable greeting card body and a holding structure disposed on the greeting card body. The holding structure removable holds a greeting insert at a predetermined location with respect to the reusable greeting card body. The reusable greeting card comprises a unique tracking identifier associated therewith disposed on the reusable greeting card body for being provided to a tracking database. A tracking method enables users of the reusable greeting card to track its reuse.

### FIELD OF THE INVENTION

The present invention relates to the field of greeting cards, and more particularly to a reusable and trackable greeting card.

### BACKGROUND OF THE INVENTION

Greeting cards are typically used to send a message or a greeting from one person to another during festive or special occasions such as, for example, Christmas, New Year's, Birthdays, and Anniversaries. Most of the greeting cards are used once and then stored or disposed of once the special occasion has passed. Worldwide greeting cards are sold in large numbers with 7.7 billion greeting cards being sold in the United States and Canada alone.

Most greeting cards are formed from a folded card creating a 4 page booklet with a picture being printed on page 1, page 2 left blank, page 3 having a message to the recipient printed thereon or being used by the sender to write the message, and page 4 being blank except for information of the card's publisher.

To reduce the waste of resources reusable greeting cards are now offered for sale. Typically, reusable greeting cards have a variety of occasions printed thereon together with a respective check box for the sender to mark with a soft pencil, which can be erased by the recipient when reusing the greeting card. Further fields allow the sender to write with a soft pencil the name of the recipient and the sender. Unfortunately, checking of a box for indicating the occasion delivers the recipient a very short and cold message. Furthermore, even the use of a soft pencil likely leaves inerasable traces or impressions on the card, for example, when pressed too hard on the paper while writing. Another disadvantage of such reusable greeting cards is that they don't allow the recipient to keep the message while reusing the greeting card.

A reusable greeting card has the potential to travel from person to person to person, thus creating a unique history. Senders of reusable greeting cards wish to follow this unique journey to see where their greeting card has gone and who it went to. Furthermore, with social networking becoming more and more mainstream, many senders of reusable greeting cards wish to become part of or start a connection with other people they may or may not know.

It is desirable to provide a reusable greeting card that enables a recipient to keep the message while reusing the greeting card.

It is also desirable to provide a reusable greeting card that enables tracking of its reuse.

It is also desirable to provide a reusable greeting card that enables sending of a public message.

### SUMMARY OF THE INVENTION

Accordingly, one object of the present invention is to provide a reusable greeting card that enables a recipient to keep the message while reusing the greeting card.

Another object of the present invention is to provide a reusable greeting card that enables tracking of its reuse.

Another object of the present invention is to provide a reusable greeting card that enables sending of a public message.

According to one aspect of the present invention, there is provided a reusable greeting card. The reusable greeting card comprises a reusable greeting card body and a holding structure disposed on the greeting card body. The holding structure removable holds a greeting insert at a predetermined location with respect to the reusable greeting card body.

According to another aspect of the present invention, there is further provided a reusable greeting card. The reusable greeting card comprises a reusable greeting card body and a holding structure disposed on the greeting card body. The holding structure removable holds a greeting insert at a predetermined location with respect to the reusable greeting card body. The reusable greeting card comprises a unique tracking identifier associated therewith disposed on the reusable greeting card body for being provided to a tracking database.

According to another aspect of the present invention, there is further provided a method for tracking a reusable greeting card. A reusable greeting card having a unique tracking identifier disposed thereon is provided. Further, a processor connected to a tracking database is provided. The tracking database has stored therein tracking data indicative of the tracking identifier of each of a plurality of reusable greeting cards and user data associated therewith. The processor receives from a user of the reusable greeting card tracking data indicative of the tracking identifier and the user data indicative of the user. The processor then compares the received tracking data with tracking data stored in the tracking database and generates a first comparison result. If the first comparison result is indicative of a match, the processor compares the received user data with the stored user data associated with the tracking data and generates a second comparison result. If the second comparison result is indicative of a match, the processor providing the stored user data associated with the tracking data. If the second comparison result is indicative of other than a match, the processor provides the received user data for storing in the tracking database. If the first comparison result is indicative of other than a match, the processor provides the received tracking data and the received user data for storing in the tracking database.

The advantage of the present invention is that it provides a reusable greeting card that enables a recipient to keep the message while reusing the greeting card.

A further advantage of the present invention is that it provides a reusable greeting card that enables tracking of its reuse.

A further advantage of the present invention is that it provides a reusable greeting card that enables sending of a public message.

### BRIEF DESCRIPTION OF THE DRAWINGS

A preferred embodiment of the present invention is described below with reference to the accompanying drawings, in which:

FIG. 1 is a simplified block diagram illustrating a perspective view of a reusable greeting card according to a preferred embodiment of the invention;

FIG. 2 is a simplified block diagram illustrating a computer system for implementing a method for tracking a reusable greeting card according to a preferred embodiment of the invention; and,

FIG. 3 is a simplified flow diagram illustrating a method for tracking a reusable greeting card according to a preferred embodiment of the invention.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

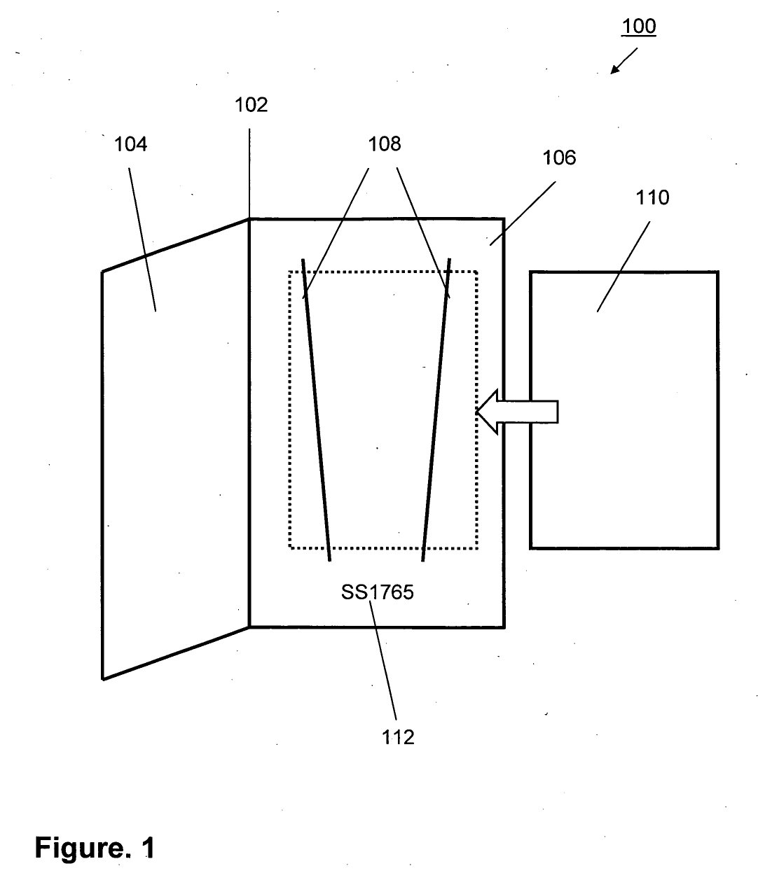

Referring to FIG. 1, a reusable greeting card 100 according to a preferred embodiment of the invention is provided. The reusable greeting card 100 comprises a reusable greeting card body 102 and a holding structure 108 disposed thereon. In use, the holding structure 108 holds in a removable fashion a greeting card insert 110 at a predetermined location with respect to the reusable greeting card body 102. Preferably, the reusable greeting card body 102 is manufactured in a standard fashion and comprises a folded card forming a four page booklet, but is not limited thereto. Further preferably, easy recyclable materials such as paper or boxboard are used for the reusable greeting card body 102, but are not limited thereto. Alternatively, other materials such as, for example, suitable textile materials or plastic materials are employed. As illustrated in FIG. 1, in the preferred embodiment the reusable greeting card body 102 comprises a left inside page 104 and a right inside page 106. The left inside page 104 is left blank while the right inside page 106 comprises the holding structure 108. A front page—placed opposite the left inside page 104—comprises, for example, a decorative picture, photograph or drawing printed thereon, while a back page—placed opposite the right inside page 106—comprises, for example, information of the card's publisher and a Universal Product Code (UPC) barcode.

Preferably, the holding structure 108 comprises two strings disposed on the right inside page 106 such that the greeting insert 110 is held in place between the strings and the greeting card body 102, as illustrated in dashed lines in FIG. 1. The strings are made of, for example, a fiber material or an elastic material such as, for example, rubber or plastic. The strings are mounted, for example, by extending end portions thereof through multiple apertures placed in the greeting card body 102 at appropriate locations and abutting the same thereto on the back page. Alternatively, the two end portions of a string are tied together on the back page. As is evident to those skilled in the art, there are numerous other possibilities for holding the greeting insert 110 such as, for example, a metal clip mounted to the right inside page, or slots disposed in the greeting card body 102 for accommodating corner portions of the greeting insert 110.

Preferably, the greeting card body 102 is sized to fit a standard #10 envelope that is readily available to most people.

The greeting inserts 110 are easily made by cutting a sheet of paper to appropriate size, i.e. users are able to make their own greeting inserts 110 by hand-writing or computer printing the greeting and cutting the paper to size.

Employment of the greeting inserts 110 and the holding structure 108 enable reusing of the greeting card 100 numerous times and allow a recipient to send a personalized greeting. A recipient of the greeting card 100 just removes the greeting insert 110—which can be kept—and replaces it with a new personalized insert 110 for sending the greeting card to another recipient.

Preferably, a unique tracking identifier 112 associated with a single reusable greeting card 100 is disposed on the greeting card body 102, for example, in the bottom portion of the right inside page 106 or the back page. The tracking identifier 112 is for being provided by a sender/recipient of the reusable greeting card 100 to a reuse database for tracking reuse of the reusable greeting card 100, as will be described herein below. The tracking identifier 112 comprises, for example, a string of numbers and/or characters—with the string having, for example, a predetermined length—which is printed on the greeting card body 102 for being read by a sender/recipient of the reusable greeting card 100.

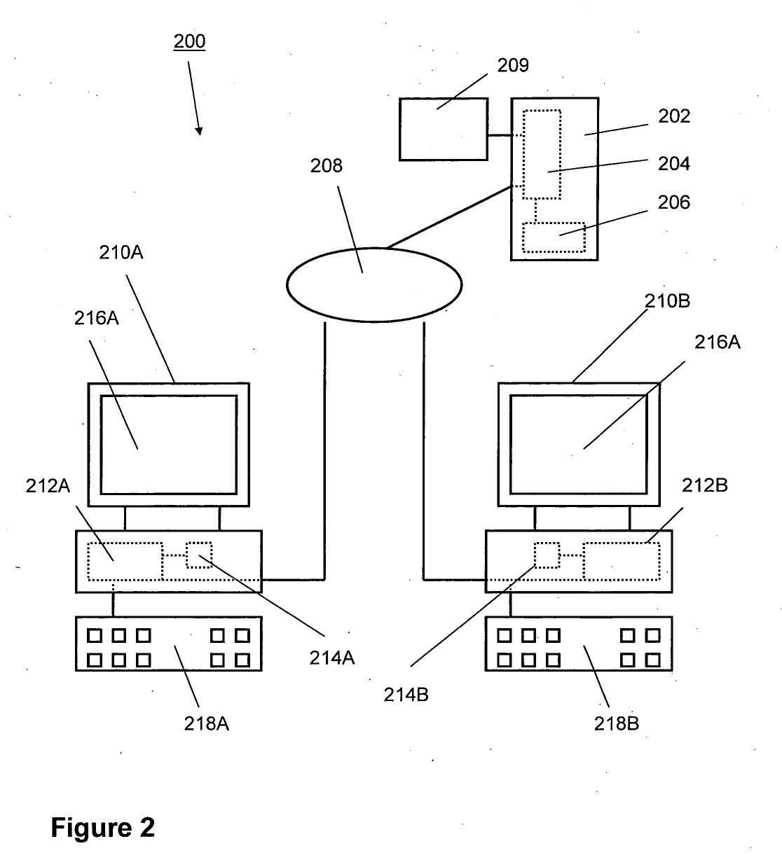

Referring to FIG. 2, a system 200 for implementing a method for tracking a reusable greeting card according to a preferred embodiment of the invention described herein below is shown. The system 200 comprises a plurality of client computers 210A, 210B such as, for example, Personal Computers (PC) or wireless portable devices. Typically, each client computer comprises: a processor 212A, 212B; memory 214A, 214B; a display 216A, 216B; and a user interface 218A, 218B. The client computers 210A, 210B are connected via a communication network 208 to server computer 202 connected to or comprising a tracking database 209. Preferably, the communication network 208 is the Internet. The method for tracking a reusable greeting card is performed, for example, by executing on processor 204 of the server computer 202 executable commands stored in storage medium 206 and communicating with processors 212A, 212B executing executable commands stored in memories 214A, 214B for enabling communication using standard Internet technologies such as Hypertext Transfer Protocol (HTTP). Performing the method for tracking a reusable greeting card enables a sender/recipient of the reusable greeting card to access the database 209 using a client computer 210A, 210B connected to the server computer 202 via the Internet 208.

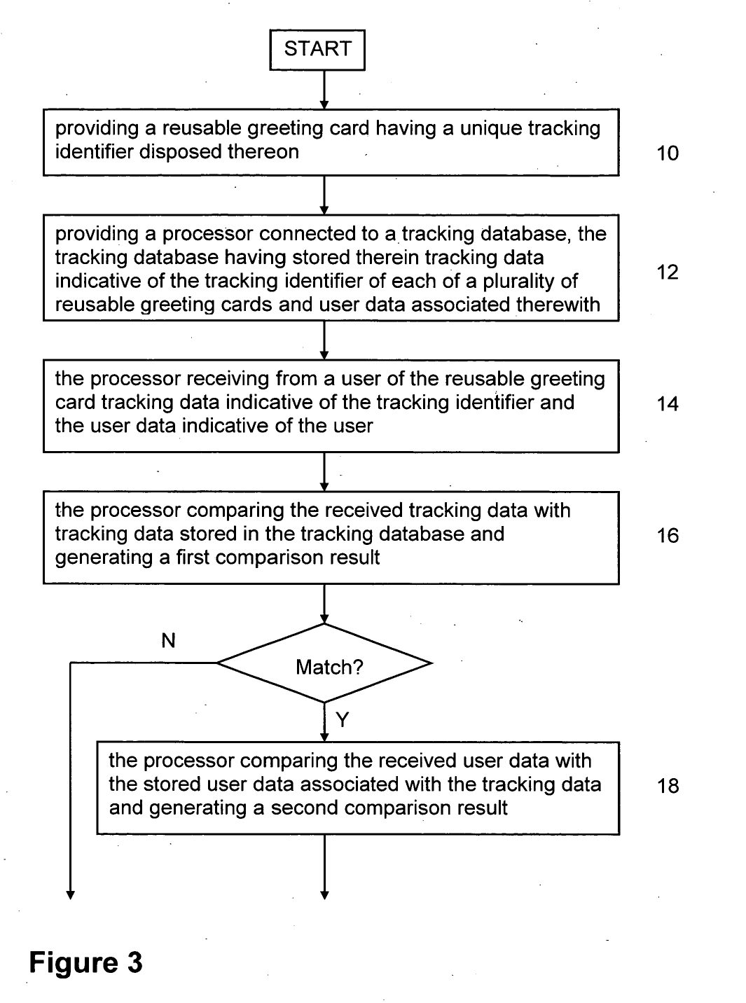

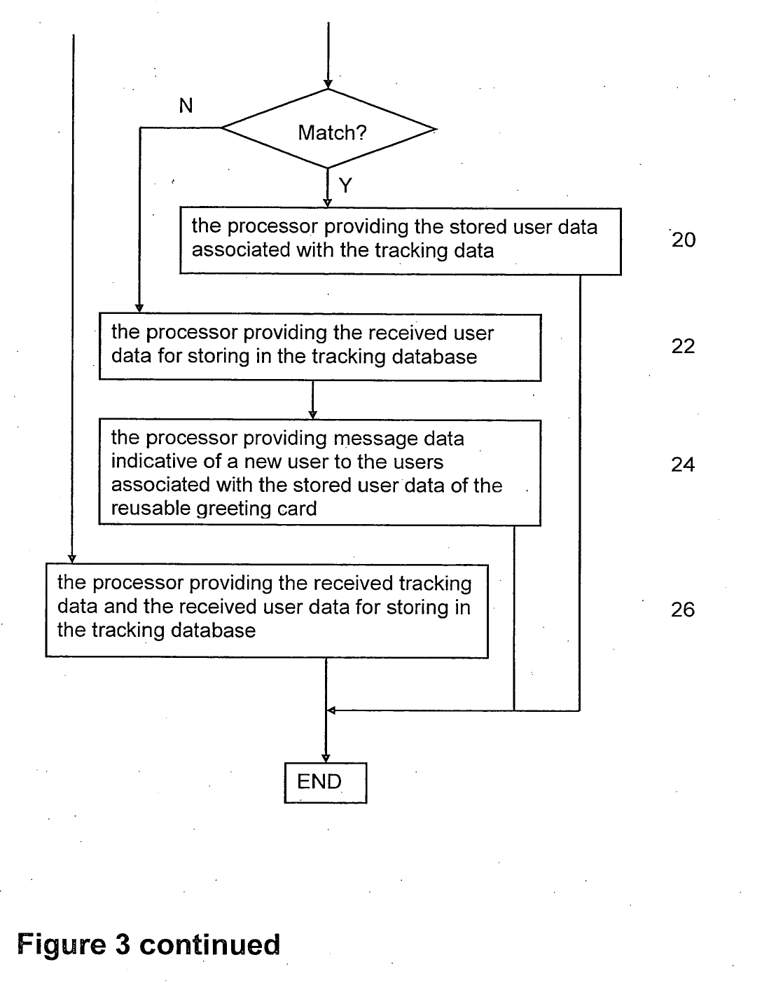

Referring to FIG. 3, a method for tracking a reusable greeting card according to a preferred embodiment of the invention is provided. At 10, a reusable greeting card having a unique tracking identifier disposed thereon is provided such as, for example, the reusable greeting card 100 having the tracking identifier 112. Further, a processor connected to a tracking database such as, for example, the processor 204 connected to the tracking database 209 is provided at 12. The tracking database has stored therein tracking data indicative of the tracking identifier of each of a plurality of reusable greeting cards and user data associated therewith. After purchase or receipt of the reusable greeting card 100, a user using a client computer 210A, 210B provides—14—tracking data indicative of the tracking identifier 112 and user data indicative of the user to the processor 204 of the server computer 202. The user data comprise, for example (subject to relevant privacy laws), data indicative of a name of the user and an address of the user. Preferably, the user is enabled to provide further information such as, for example, further contact information in the form of telephone number and/or email address, information about the occasion for sending the reusable greeting card, and a personal message. Optionally, the user is enabled to determine if the personal message is accessible only to users of the specific greeting card or to all users of the plurality of greeting cards stored in the tracking database 209.

Upon receipt, the processor 204 compares—16—the received tracking data with tracking data stored in the tracking database 209 and generates a first comparison result. If the first comparison result is indicative of a match, the processor 204 compares—18—the received user data with the stored user data associated with the tracking data and generates a second comparison result. If the second comparison result is indicative of a match, the processor 204 provides—20—the stored user data associated with the tracking data to the client computer 210A, 210B of the user enabling the user to track the reuse of the greeting card and retrieving information about the recipients. If the second comparison result is indicative of other than a match, the processor 204 provides—22—the received user data for storing in the tracking database 209. Optionally, the processor 204 provides the stored user data associated with the tracking data to the client computer 210A, 210B of the user enabling the user to track previous recipients of the greeting card. Further optionally, the processor 204 provides—24— message dataindicative of a new user to the users associated with the stored user data of the reusable greeting card if the second comparison result is indicative of other than a match, thus alerting previous users of the new user. The previous users may then access the database to retrieve the information provided by the new user—step 20. If the first comparison result is indicative of other than a match, the processor 204 provides—26—the received tracking data and the received user data for storing in the tracking database 209.

Optionally, a user is enabled to access a plurality of template greetings if the first comparison result is indicative of a match. For example, the plurality of template greetings is generated for various occasions and stored in memory 206 of the server computer 202. A user is then enabled to select a template greeting—which is preferably displayed on the display 216A, 216B of the client computer 210A, 210B—and print the selected greeting.

The above method for tracking a reusable greeting card is implemented using standard programming technology such as, for example, object oriented programming and Structured Query Language (SQL).

The present invention has been described herein with regard to preferred embodiments. However, it will be obvious to persons skilled in the art that a number of variations and modifications can be made without departing from the scope of the invention as described herein.

What is claimed is:

1. A reusable greeting card comprising:
a reusable greeting card body; and,
a holding structure disposed on the greeting card body, the holding structure for removable holding a greeting insert at a predetermined location with respect to the reusable greeting card body.

2. A reusable greeting card as defined in claim 1 comprising a unique tracking identifier associated therewith disposed on the reusable greeting card body, the tracking identifier for being provided to a tracking database for tracking reuse of the reusable greeting card.

3. A reusable greeting card as defined in claim 1 wherein the greeting card body comprises a folded card forming a four page booklet.

4. A reusable greeting card as defined in claim 1 wherein the holding structure comprises at least a string mounted to the card body for holding the greeting insert between the string and the card body.

5. A reusable greeting card as defined in claim 1 comprising at least a greeting insert.

6. A method comprising:
providing a reusable greeting card having a unique tracking identifier disposed thereon;
providing a processor connected to a tracking database, the tracking database having stored therein tracking data indicative of the tracking identifier of each of a plurality of reusable greeting cards and user data associated therewith;
the processor receiving from a user of the reusable greeting card tracking data indicative of the tracking identifier and the user data indicative of the user;
the processor comparing the received tracking data with tracking data stored in the tracking database and generating a first comparison result;
the processor comparing the received user data with the stored user data associated with the tracking data and generating a second comparison result if the first comparison result is indicative of a match;
the processor providing the stored user data associated with the tracking data if the second comparison result is indicative of a match; and,
the processor providing the received user data for storing in the tracking database if the second comparison result is indicative of other than a match.

7. A method as defined in claim 6 comprising the processor providing the received tracking data and the received user data for storing in the tracking database if the first comparison result is indicative of other than a match.

8. A method as defined in claim 6 wherein the user data comprises data indicative of at least one of a name of the user, address of the user, occasion for sending the card, and a personal message.

9. A method as defined in claim 6 comprising the processor providing message data indicative of a new user to the users associated with the stored user data of the reusable greeting card if the second comparison result is indicative of other than a match.

10. A method as defined in claim 6 wherein the reusable greeting card is provided as a greeting card body having a holding structure disposed thereon for removable holding a greeting insert.

11. A method as defined in claim 10 comprising providing at least a template greeting for being provided on the greeting insert.

12. A method as defined in claim 11 comprising generating the template greeting data in dependence upon received user input data.
